(19) United States
(12) Patent Application Publication
(10) Pub. No.: US 2009/0234975 A1
(43) Pub. Date: Sep. 17, 2009

(54) Sliding and rotate-to-open hinge structure of a portable electronic device

(75) Inventors: Jung-Wen Chang, Tao Yuan Shien (TW); Chih-Hsien Wu, Changhwa Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/222,641

(22) Filed: Aug. 13, 2008

(30) Foreign Application Priority Data
Mar. 17, 2008 (TW) 97204576

(51) Int. Cl. G06F 3/00; B65D 43/20

(52) U.S. Cl. 710/1; 220/345.1

(57) ABSTRACT

This invention presents a sliding and rotate-to-open hinge structure of a portable electronic device which has an upper cover and a base. The hinge structure is provided to pivotally connect the upper cover and the base such that the upper cover could be slid and rotated relative to the base.

### RELATED APPLICATIONS

This application claims priority to Taiwan Application Serial Number 97204576, filed Mar. 17, 2008, which is herein incorporated by reference.

### BACKGROUND

1. Field of Invention

The presented invention relates to a sliding and rotate-to-open hinge structure. More particularly, the presented invention relates to sliding and rotate-to-open hinge structure of a portable electronic device.

2. Description of Related Art

In present portable electronic device technologies, there is a trend for systems to become smaller, lighter, thinner, smaller in volume and to equip with more and more function and diversified. Some portable electronic devices are designed to have two parts with an upper cover and a base for arranging the display screen and the input unit separately. The display screen can be arranged on the upper cover and the input unit, such as a keyboard or a touchpad, can be arranged in the base.

However, in prior art, a hinge structure is needed to connect the upper cover and the base pivotally with a large internal space of the device and therefore doesn't comply with the trends for size minimization.

### SUMMARY

For this reason, the invention provides a sliding and rotate-to-open hinge structure of a portable electronic device. The hinge structure for both sliding and rotating is designed to pivotally connect the upper cover and the base of the portable electronic device. Therefore, the upper cover of the portable electronic device can be slid and then rotated the base.

The sliding and rotate-to-open hinge structure of this invention comprises: a pivot for linking the upper cover and the base pivotingly; a sliding clip with a sleeve at an end on one side of the sliding clip and a rail clip on the other side of the sliding clip, wherein the sleeve is rotatably connected with the pivot on the base so that the sliding clip can be rotated relative to the base; and at least a straight rail being clasped by the rail clip of the sliding clip, for moving forwards and backwards within a limited range.

By using the sliding and rotate-to-open hinge structure of this invention, the upper cover of the portable electronic device can be rotated and raised relative to the base in front of the input device such as a keyboard, a touch pad etc. This increases the variety of functional applications of the portable electronic device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a perspective view of a preferred embodiment of the sliding and rotate-to-open hinge structure of this invention;

FIG. 2 illustrates an exploded view of the preferred embodiment of the sliding and rotate-to-open hinge structure of this invention; and

FIGS. 3A, 3B and 3C illustrate continuous movements of the preferred embodiment of the sliding and rotate-to-open hinge structure of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

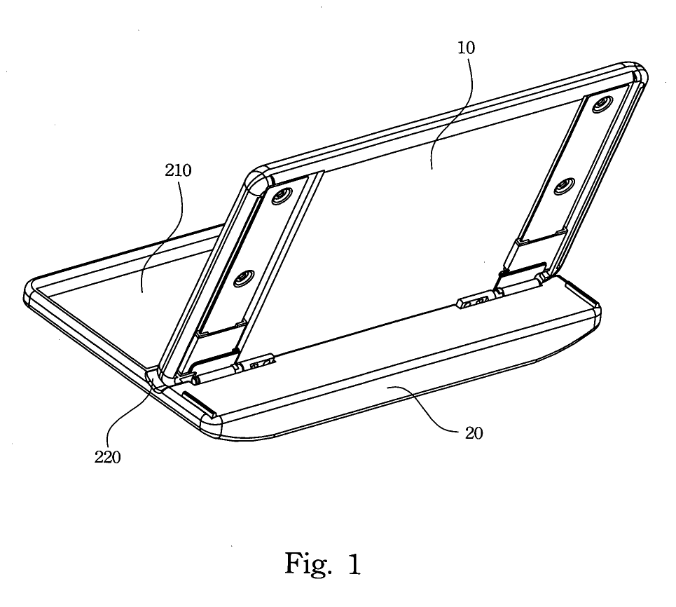

FIG. 1 illustrates a perspective view of a preferred embodiment of the sliding and rotate-to-open hinge structure of this invention. As shown in FIG. 1, the sliding and rotate-to-open hinge structure of this invention is implemented on portable electronic devices such as a mobile phone, a Personnel Digital Assistant (PDA), an Ultra-Mobile Personnel Computer (UMPC), a Mobile Internet Device (MID) etc. By using the sliding and rotate-to-open hinge structure, the upper cover 10 of the portable electronic device can be rotated and raised relative to the base 20, thus increasing the varieties and the functional applications of a portable electronic device.

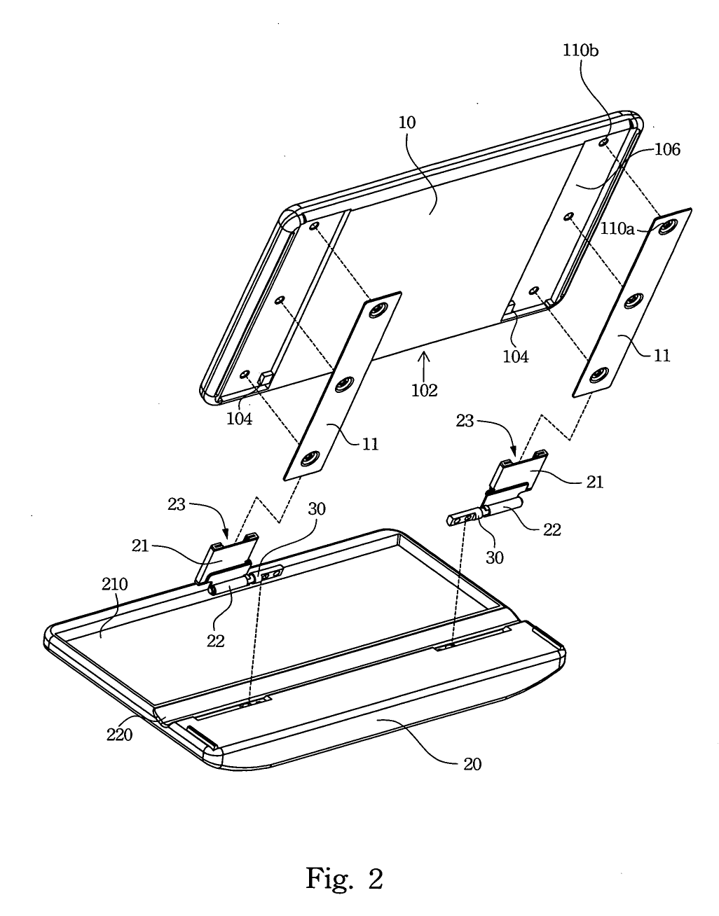

FIG. 2 illustrates an exploded view of the preferred embodiment of the sliding and rotate-to-open hinge structure of this invention. As shown in FIG. 2, the sliding and rotate-to-open hinge structure comprises an upper cover 10, a base 20, a straight rail 11, a sliding clip 21 and a pivot 30. The upper cover 10, which connects to the base 20, can be equipped with a display screen of the portable electronic device. The upper cover 10 has a bottom 102 at one side thereof and indentations 106 at two sides on the back of the upper cover 10. The amount of indentations can be arranged according to the number of straight rails 11, wherein the indentation 106 has a retaining block 104 and a fixing structure 110b. The indentation 106 is disposed at the position corresponding to the straight rail 11 to contain the straight rail 11. And the straight rail 11 is fastened with the indentation 106 by the fixing structure 110a and the fixing structure 110b, wherein the fixing structures 110a and 110b can be implemented as a combination of a screw structure and a bolt structure. The base 20, a supporting base of the portable electronic device can be equipped with an input device such as a keyboard, a touch pad, and etc. The upper surface 210 further includes a trench 220 to accommodate the bottom 102 of the upper cover 10 when the upper cover 10 is turned over relative to the base 20. That is, when the upper cover 10 is turned over relative to the base 20, the bottom 102 of the upper cover 10 can swivel into the trench 220. Also, the upper cover 10 can be turned only when the bottom 102 of the upper cover 10 is aligned with the trench 220. The pivot 30 is secured on the base 20 to attach the upper cover 10 and the base 20 together, and is operable to swing the upper cover 10 relative the base 20. The sliding clip 21 has a sleeve 22 at one end thereof, and the sleeve 22 is rotatably connected with the pivot 30 so that the sliding clip 21 can be rotated relative the base 20. Therefore, the sliding clip 21 can be turned upright from the base 20 or turned against the upper surface 210 of the base 20 by means of the pivot 30 and the sleeve 22. The sliding clip 21 has a rail clip 23 at the other end opposite to the sleeve 22. The straight rail 11 is disposed in the indentation 106 of the upper cover 10 corresponding to the sliding clip 21. The rail clip 23 clasps the straight rail 11 such that the straight rail 11 can move backwards and forwards within a limited range relative to the rail clip 23 such that the upper cover 10 can be pushed backwards and forwards relative to the base 20. The limited range is defined by the position of the retaining block 104 within the indentation 106.

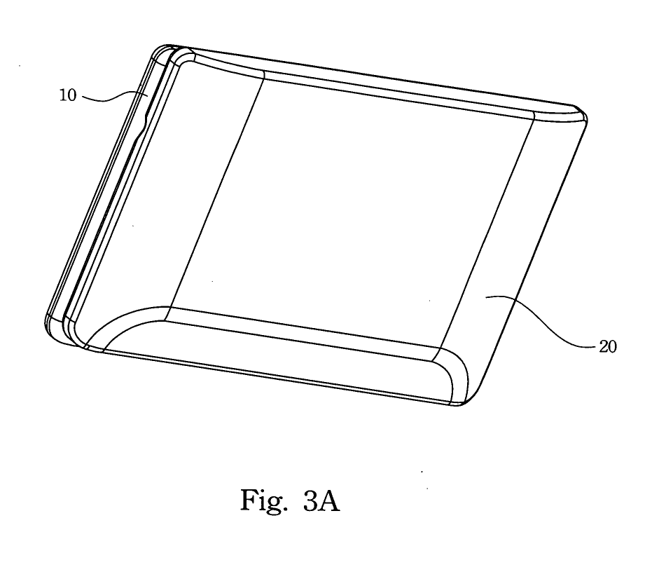

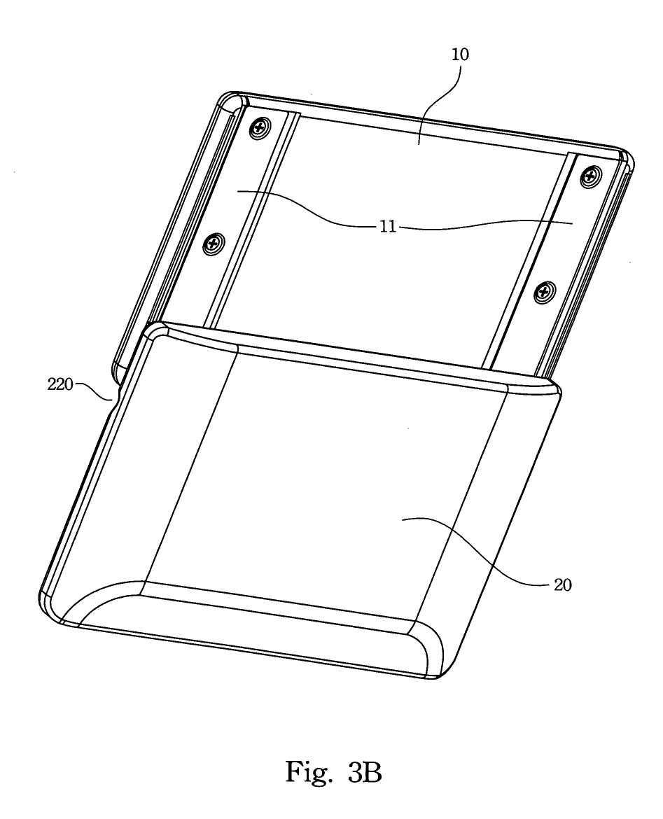

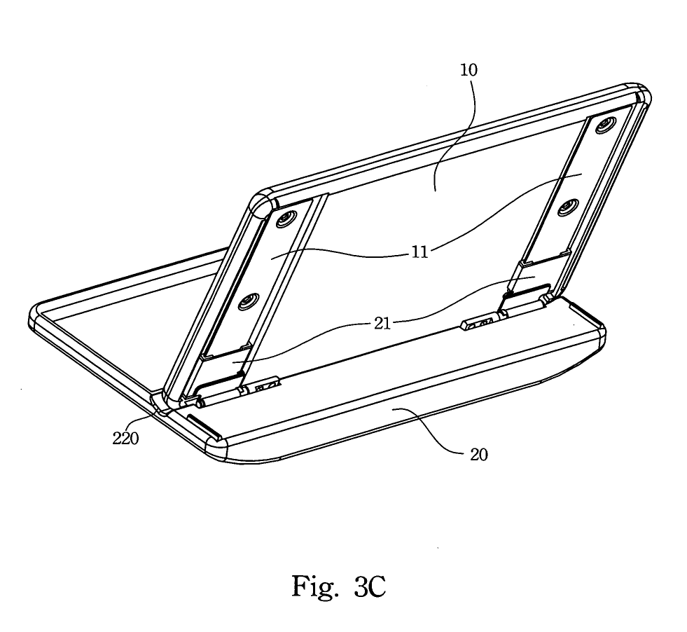

FIGS. 3A, 3B and 3C illustrate continuous movements of the preferred embodiment of the sliding and rotate-to-open hinge structure of this invention. Firstly, the upper cover 10 is slid relative to the base 20, from an initial position where the upper surface 210 fully overlapping upon the base 20 (as illustrated in FIG. 3A), to an opening position where the retaining block 104 is in contact with the sliding clip 21 (as illustrated in FIG. 3B) and the upper cover 10 is pushed until its bottom 102 is aligned with the trench 220 at the same time. Then, the upper cover 10 can be turned over relative to the base 20 by turning both the straight rail 11 and the sliding clip 21, thus swiveling the bottom 102 of the upper cover 10 into the trench 220 and raising the upper cover 10 on the base 20, as shown in FIG. 3C.

The invention provides portable electronic devices a function to raise the upper cover on the base which may includes input devices such as a keyboard, a touch pad and etc. Thus increases the varieties and the functional applications of a portable electronic device.

Although the present invention has been described in considerable detail with-reference certain embodiments thereof, other embodiments are possible. Therefore, their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A sliding and rotate-to-open hinge structure of a portable electronic device having an upper cover and a base, wherein the hinge structure comprises:
a pivot for pivoting the upper cover and the base;
a sliding clip having a sleeve at one side and a rail clip on the other side, wherein the sleeve is rotatably connected with the pivot so that the sliding clip can be rotated relative the base; and
at least a straight rail being clasped by the rail clip of the sliding clip, for moving forwards and backwards within a limited range.

2. The hinge structure of claim 1, wherein the upper cover has a bottom and at least one indentation; the straight rail is disposed within the indentation.

3. The hinge structure of claim 2, wherein the base has an input unit.

4. The hinge structure of claim 2, wherein the indentation and the straight rail respectively have a fixing structure for fastening the straight rail in the indentation.

5. The hinge structure of claim 2, wherein the indentation further comprises a retaining block to define the limited range.

6. The hinge structure of claim 5, wherein the base comprises a trench.

7. The hinge structure of claim 6, wherein when the bottom of the upper cover is aligned with the trench, the retaining block is in contact with the sliding clip.

8. The hinge structure of claim 6, wherein the bottom of the upper cover swivels into the trench when the upper cover is turned over relative to the base.

9. The hinge structure of claim 6, wherein when the upper cover is turned over relative to the base, both the straight rail and the sliding clip are turned together relative to the base.

10. A portable electronic device, comprising:
an upper cover having a bottom at one side;
a base having a trench on an upper surface; and
a hinge structure comprising:
a pivot for pivoting the upper cover and the base;
a sliding clip having a sleeve at one side and a rail clip on the other side, wherein the sleeve is rotatably connected with the pivot on the base such that so that the sliding clip can be rotated relative the base; and
at least a straight rail being clasped by the rail clip of the sliding clip, for moving forwards and backwards within a limited range.

11. The portable electronic device of claim 10, wherein the base has an input unit.

12. The portable electronic device of claim 11, wherein the upper cover has a display screen.

13. The portable electronic device of claim 10, wherein the upper cover further comprises at least one indentation; the straight rail is disposed within the indentation.

14. The portable electronic device of claim 13, wherein the indentation to and the straight rail respectively have a fixing structure for fastening the straight rail in the indentation.

15. The portable electronic device of claim 13, wherein the indentation further comprises a retaining block for retaining the upper cover to move within the limited range.

16. The portable electronic device of claim 15, wherein the upper cover is capable of being turned only when the bottom of the upper cover is aligned with the trench.

17. The portable electronic device of claim 16, wherein when the bottom of the upper cover is aligned with the trench, the retaining block is in contact with the sliding clip.

18. The portable electronic device of claim 17, wherein the bottom of the upper cover swivels into the trench when the upper cover is turned over relative to the base.

19. The portable electronic device of claim 17, wherein when the upper cover is turned over relative to the base, both the straight rail and the sliding clip are turned together relative to the base.

20. The portable electronic device of claim 19, wherein the portable electronic device is an Ultra-Mobile Personnel Computer (UMPC).
